(19) United States
(12) Patent Application Publication
(10) Pub. No.: US 2013/0052621 A1
(43) Pub. Date: Feb. 28, 2013

(54) MENTAL STATE ANALYSIS OF VOTERS

(71) Applicant: Affectiva, Inc., Waltham, MA (US)

(72) Inventors: Rana el Kaliouby, Waltham, MA (US); Andrew Edwin Dreisch, San Jose, CA (US); Daniel McDuff, Cambridge, MA (US); John P. Nauseef, Dayton, OH (US); Rosalind Wright Picard, Newtonville, MA (US); Lynda Radosevich, New York, NY (US)

(73) Assignee: AFFECTIVA, INC., Waltham, MA (US)

(21) Appl. No.: 13/656,642

(22) Filed: Oct. 19, 2012

Related U.S. Application Data
(63) Continuation-in-part of application No. 13/153,745, filed on Jun. 6, 2011.
Application No. 13/153,745 is a continuation-in-part of application No. 13/297,342, filed on Nov. 16, 2011.
(60) Provisional application No. 61/549,560, filed on Oct. 20, 2011.
(60) Provisional application No. 61/619,914, filed on Apr. 3, 2012.
(60) Provisional application No. 61/703,756, filed on Sep. 20, 2012.
(60) Provisional application No. 61/352,166, filed on Jun. 7, 2010.
(60) Provisional application No. 61/388,002, filed on Sep. 30, 2010.
(60) Provisional application No. 61/414,451, filed on Nov. 17, 2010.
(60) Provisional application No. 61/439,913, filed on Feb. 6, 2011.
(60) Provisional application No. 61/447,089, filed on Feb. 27, 2011.
(60) Provisional application No. 61/447,464, filed on Feb. 28, 2011.
(60) Provisional application No. 61/467,209, filed on Mar. 24, 2011.
(60) Provisional application No. 61/414,451, filed on Nov. 17, 2010.
(60) Provisional application No. 61/439,913, filed on Feb. 6, 2011.
(60) Provisional application No. 61/447,089, filed on Feb. 27, 2011.
(60) Provisional application No. 61/447,464, filed on Feb. 28, 2011.
(60) Provisional application No. 61/467,209, filed on Mar. 24, 2011.
(60) Provisional application No. 61/549,560, filed on Oct. 20, 2011.

(51) Int. Cl. G09B 19/00

(52) U.S. Cl. 434/236

(57) ABSTRACT

Analysis of mental states of voters is provided to enable data analysis pertaining to candidate interactions. Candidate interactions include such things as political debates, political advertisements, news reports, and political speeches. Data is captured for an individual voter or group of voters where the data includes facial information and physiological information. Facial and physiological information is gathered for the group of voters. In some embodiments, demographics information is collected and used as a criterion for rendering the mental states of the voters in a graphical format which is synchronized to the candidate interaction.

### RELATED APPLICATIONS

This application claims the benefit of U.S. provisional patent applications “Mental State Analysis of Voters” Ser. No. 61549560, filed Oct. 20, 2011, “Affect Based Political Advertisement Analysis” Ser. No. 61/619,914, filed Apr. 3, 2012, and “Facial Analysis to Detect Asymmetric Expressions” Ser. No. 61/703,756, filed Sep. 20, 2012. This application is also a continuation-in-part of U.S. patent application “Mental State Analysis Using Web Services” Ser. No. 13/153,745, filed Jun. 6, 2011 which claims the benefit of U.S. provisional patent applications “Mental State Analysis Through Web Based Indexing” Ser. No. 61/352,166, filed Jun. 7, 2010, “Measuring Affective Data for Web-Enabled Applications” Ser. No. 61/388,002, filed Sep. 30, 2010, “Sharing Affect Data Across a Social Network” Ser. No. 61/414,451, filed Nov. 17, 2010, “Using Affect Within a Gaming Context” Ser. No. 61/439,913, filed Feb. 6, 2011, “Recommendation and Visualization of Affect Responses to Videos” Ser. No. 61/447,089, filed Feb. 27, 2011, “Video Ranking Based on Affect” Ser. No. 61/447,464, filed Feb. 28, 2011, and “Baseline Face Analysis” Ser. No. 61/467,209, filed Mar. 24, 2011. This application is also a continuation-in-part of U.S. patent application “Sharing Affect Across a Social Network” Ser. No. 13/297,342, filed Nov. 16, 2011 which claims the benefit of U.S. provisional patent applications “Sharing Affect Data Across a Social Network” Ser. No. 61/414,451, filed Nov. 17, 2010, “Using Affect Within a Gaming Context” Ser. No. 61/439,913, filed Feb. 6, 2011, “Recommendation and Visualization of Affect Responses to Videos” Ser. No. 61/447,089, filed Feb. 27, 2011, “Video Ranking Based on Affect” Ser. No. 61/447,464, filed Feb. 28, 2011, “Baseline Face Analysis” Ser. No. 61/467,209, filed Mar. 24, 2011, and “Mental State Analysis of Voters” Ser. No. 61/549,560, filed Oct. 20, 2011. The foregoing applications are hereby incorporated by reference in their entirety.

### FIELD OF ART

This application relates generally to the analysis of mental states and more particularly to evaluation of mental states for voters.

### BACKGROUND

The evaluation of mental states is key to understanding people and the way in which they react to the world around them. Mental states run a broad gamut from happiness to sadness, from contentedness to worry, and from excited to calm, as well as numerous others. These mental states are experienced in response to everyday events such as frustration during a traffic jam, boredom while standing in line, and impatience while waiting for a cup of coffee. Individuals may become rather perceptive and empathetic based on evaluating and understanding others' mental states but automated evaluation of mental states is far more challenging. An empathetic person may perceive another's being anxious or joyful and respond accordingly. The ability by which one person perceives another's emotional state may be quite difficult to summarize and has often been communicated as having a “gut feel.”

Many mental states, such as confusion, concentration, and worry, may be identified to aid in the understanding of an individual or group of people. People can collectively respond with fear or anxiety, such as after witnessing a catastrophe. Likewise, people can collectively respond with happy enthusiasm, such as when their sports team wins a victory. Certain facial expressions and head gestures may be used to identify a mental state that a person is experiencing. Limited automation has been performed in the evaluation of mental states based on facial expressions. Certain physiological conditions may provide telling indications of a person's state of mind and have been used in a crude fashion as in an apparatus used for lie detector or polygraph tests.

### SUMMARY

Analysis of mental states may be performed while voters or potential voters observe a candidate as he or she interacts with an audience or other candidates. Analysis may indicate whether a group of voters will be favorably disposed to a candidate in general or to specific message points communicated by a candidate. A computer implemented method for voter analysis is disclosed comprising: collecting mental state data from a plurality of people as they observe a candidate interaction; uploading information, to a server, based on the mental state data from the plurality of people who observe the candidate interaction; receiving aggregated mental state information on the plurality of people who observe the candidate interaction; and rendering an output based on the aggregated mental state information.

The information, which is uploaded, may include one or more of the mental state data, analysis of the mental state data, and a probability score for mental states. The method may further comprise inferring mental states based on the mental state data which was collected wherein the mental states include one or more of frustration, confusion, disappointment, hesitation, cognitive overload, focusing, engagement, attention, boredom, exploration, confidence, trust, delight, disgust, skepticism, doubt, and satisfaction. The collecting may be part of a voter polling process. The aggregated mental state information may allow evaluation of a collective mental state of the plurality of people. The method may further comprise developing norms based on the aggregated mental state information. The method may further comprise developing an affinity group based on the aggregated mental state information. The method may further comprise sharing the mental state information across a social network. The aggregated mental state information may be aggregated separately for multiple demographic groups. The multiple demographic groups may be based on one or more of age, political affiliation, gender, geographic location, and ethnicity. The rendering may be accomplished using a dashboard. The rendering may include highlights from the candidate interaction. The rendering may include an analysis of a candidate within the candidate interaction. The method may further comprise analyzing the candidate for congruency with the plurality of people who observe the candidate interaction. The method may further comprise aggregating information to generate the aggregated mental state information from a plurality of people. The method may further comprise rendering the aggregated mental state information so that one of multiple demographic groups is emphasized. The candidate interaction may include one or more of a debate, a town hall discussion, a campaign appearance, a political advertisement, a testing of messaging, a live event, and a recorded event. The plurality of people may be in a single audience. The plurality of people may be distributed in multiple locations. A portion of the plurality of people may be in an audience and a portion of the plurality of people may be distributed in multiple locations.

The method may further comprise tracking of eyes to identify a portion of the candidate interaction for which the mental state data is collected. The method may further comprise analyzing election behavior for the plurality of people on which mental state data was collected. The election behavior may include information which candidate the plurality of people voted for. The election behavior may include information on not voting by a subset of the plurality of people. The method may further comprise comparing the mental state data to norms which have been determined. The method may further comprise comparing the mental state data with self-report information collected from the plurality of people. Rendering the aggregated mental state information may include highlighting portions of the candidate interaction based on the mental state data collected. The mental state data may include one of a group comprising facial data, physiological data, and accelerometer readings. The facial data may further comprise head gestures. The facial data may include information on one or more of action units, head gestures, smirks, smiles, brow furrows, squints, lowered eyebrows, raised eyebrows, and attention. A webcam may be used to capture one or more of the facial data and the physiological data. A webcam may be used for each of the plurality of people. A camera may be used to capture mental state data on multiple people from the plurality of people. The physiological data may include one or more of a group comprising electrodermal activity, heart rate, heart rate variability, or respiration. The physiological data may be collected without contacting the plurality of people. The aggregated mental state information may include one or more of a cognitive state or an emotional state. The aggregated mental state information may include categorization based on valence and arousal. The method may further comprise opting in for the collecting of mental state data. The method may further comprise opting in for the uploading of the information.

In embodiments, a computer program product embodied in a non-transitory computer readable medium for voter analysis may comprise: code for collecting mental state data from a plurality of people as they observe a candidate interaction; code for uploading information, to a server, based on the mental state data from the plurality of people who observe the candidate interaction; code for receiving aggregated mental state information on the plurality of people who observe the candidate interaction; and code for rendering an output based on the aggregated mental state information. In some embodiments, a computer system for voter analysis may comprise: a memory which stores instructions; one or more processors attached to the memory wherein the one or more processors, when executing the instructions which are stored, are configured to: collect mental state data from a plurality of people as they observe a candidate interaction; upload information, to a server, based on the mental state data from the plurality of people who observe the candidate interaction; receive aggregated mental state information on the plurality of people who observe the candidate interaction; and render an output based on the aggregated mental state information. In embodiments, a computer implemented method for voter analysis may comprise: receiving mental state data, which was collected, from a plurality of people as they observe a candidate interaction; analyzing the mental state data, which was received, to produce an aggregated mental state information on the plurality of people; and sending the aggregated mental state information to a client machine so that an analysis of the mental state data is rendered based on the aggregated mental state information

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for analysis of voters.

FIG. 2 is a diagram for collecting facial responses from a group.

FIG. 3 is a diagram describing capturing facial response to candidate interaction.

FIG. 4 is a diagram representing physiological analysis.

FIG. 5 is an example graphical rendering of mental state analysis.

FIG. 6 is an example graphical rendering with demographic information.

FIG. 7 is an example rendering including norms.

FIG. 8 is an example graphical rendering including both the candidate interaction and a video of voter reaction.

FIG. 9 is an example graphical rendering showing a candidate interaction along with voter reaction.

FIG. 10 is a flow diagram for analyzing voter reaction.

FIG. 11 is a diagram of a system for analyzing voter response.

### DETAILED DESCRIPTION

The present disclosure provides a description of various methods and systems for analyzing people's mental states, particularly where the people are voters or potential voters. Voters may observe candidate interactions and have data collected on their mental states. Computer analysis is performed of facial and/or physiological data to determine mental states of the voters as they observe various types of candidate interactions. Mental state analysis can be used to evaluate a person's or people's reaction to a candidate or message by a candidate. This analysis can be used to tailor messaging and evaluate communications by a candidate against norms that are developed. Various demographic groups can be analyzed for responses to a political event. Affinity groups can be developed based on mental state analysis.

A mental state may be a cognitive state or an emotional state and these can be broadly covered using the term affect. Examples of emotional states include happiness or sadness while examples of cognitive states include concentration or confusion. Observing, capturing, and analyzing these mental states can yield significant information about voters' reactions to various stimuli. Some terms commonly used in evaluation of mental states are arousal and valence. Arousal is an indication of the amount of activation or excitement of a person. Valence is an indication of whether a person is positively or negatively disposed. Determination of affect may include analysis of arousal and valence. Affect may include analysis of facial data for expressions such as smiles or brow furrowing. Analysis may be as simple as tracking when someone smiles or when someone frowns. Mental states may be identified by embodiments of the present invention and may include, but are not limited to, frustration, confusion, disappointment, hesitation, cognitive overload, focusing, engagement, attention, boredom, exploration, confidence, trust, delight, disgust, skepticism, doubt, and satisfaction. Knowledge of the mental states voters are experiencing can provide keen insight during political campaigns.

The present disclosure provides a description of various methods and systems associated with performing analysis of mental states of voters. In this disclosure, the term “voters” comprises voters, likely voters, and eligible voters. Embodiments of the present invention provide an automated system and method for analyzing the metal states of voters. Example usages may comprise analyzing the mental state of voters in response to a candidate interaction. A candidate interaction may include, but is not limited to, a political debate, a politician speech, a news report, a campaign appearance, a town hall discussion, and a political advertisement. The candidate interaction may be a previously recorded event or a live event, such as a political convention.

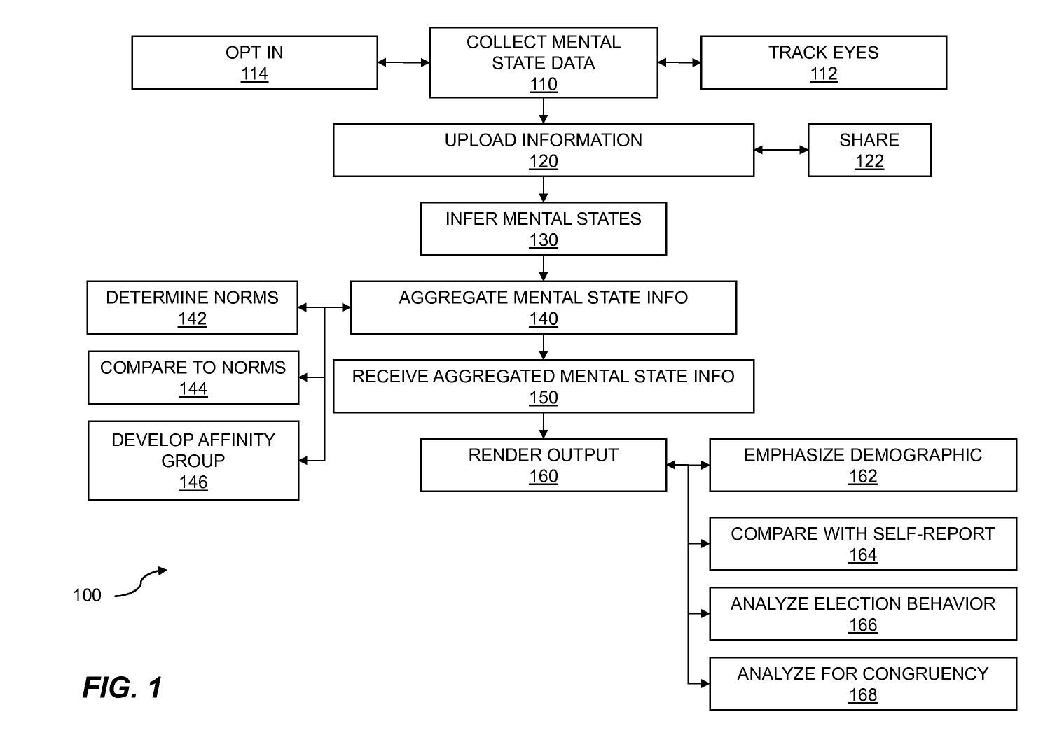

FIG. 1 is a flow diagram for analysis of the mental state of voters. The flow 100 describes a computer implemented method for voter analysis. The flow 100 may begin with collecting mental state data 110 from a plurality of people as they observe a candidate interaction. The candidate interaction may include a debate, a town hall discussion, a campaign appearance, a political advertisement, a testing of messaging, and the like. The candidate interaction may include a live event. The collecting may be part of a voter polling process. A voter may be asked a series of questions about a candidate or group of candidates. Mental state data may be collected as the voter responds to the questions. The data on the individual may include facial expressions, physiological information, and accelerometer readings. The facial expressions may further comprise head gestures. The physiological information may include electrodermal activity, skin temperature, heart rate, heart rate variability, and respiration. In embodiments, data, including physiological data may be collected without contacting an individual voter. A voter may be provided an opt-in option to authorize the collection and analysis of mental state data. The group of voters may be part of a single audience, such as all being in one room watching a political debate. Alternatively, the group of voters may be distributed in multiple locations. In another embodiment, a portion of the group of voters may be in an audience and a portion of the group of voters may be distributed in multiple locations. In some embodiments, the candidate interaction may be viewed live by some and later by others. The reactions from both the live and asynchronous viewings may be aggregated together.

The flow 100 may include tracking of eyes 112 to identify a portion of the candidate interaction for which the mental state data is collected. For example, eye tracking may be used to identify annoying mannerisms, distracting clothing, or the like. The flow 100 may include opting in 114 before the collecting of mental state data. A voter or group of voters may be asked permission before data collection begins.

The flow 100 continues with uploading information 120 to a server, based on the mental state data from the plurality of people who observe the candidate interaction. In some embodiments, opting in may be performed before the uploading of the information. The information which is uploaded may include one or more of the mental state data, analysis of the mental state data, and a probability score for mental states. Some analyzing may be done on a client computer before the uploading. The flow 100 may include sharing 122 the mental state information across a social network. The sharing may include communicating by email, by Facebook™, by Twitter™, by LinkedIn™, MySpace™, Google+™, or through some other social networking site. They sharing may be accomplished by sharing a link. The sharing may include a candidate interaction becoming viral. In some embodiments, the sharing may be targeted.

The flow 100 may continue with inferring mental states 130 based on the mental state data which was collected wherein the mental states include one or more of frustration, confusion, disappointment, hesitation, cognitive overload, focusing, engagement, attention, boredom, exploration, confidence, trust, delight, disgust, skepticism, doubt, and satisfaction. These mental states may be detected in response to a candidate interaction or a specific portion thereof. The flow 100 may include aggregating information to generate the aggregated mental state information 140 from a plurality of people. The aggregation may be based on demographic groups. In embodiments, the aggregation may take place before the inferring of mental states. The flow 100 may include developing norms 142 based on the aggregated mental state information. The norms may identify expected responses by viewers to candidate interactions. The flow 100 may include comparing the mental state to norms 144 which have been determined. When values different from the norms are encountered, more careful analysis maybe prudent. The flow 100 may include developing an affinity group 146 based on the aggregated mental state information. Viewers with common responses may be grouped together. This group may be encouraged to vote, encouraged to donate, or encouraged to become more politically active, to name several possibilities.

The flow 100 continues with receiving aggregated mental state information 150 on the plurality of people who observe the candidate interaction. The aggregated mental state information may include one of a cognitive state and an emotional state. The aggregated mental state information may include categorization based on valence and arousal. The aggregated mental state information may allow evaluation of a collective mental state of a plurality of voters. Mental state data may be aggregated from a group of people, i.e. voters, who have observed a particular candidate interaction. The aggregated information may be used to infer mental states of a group of voters. This information may allow evaluation of a collective mental state of a group of voters. The group of voters may correspond to a particular demographic, such as democrats, women, or people between the ages of 18 and 30, by way of example.

The flow 100 continues with rendering an output 160 based on the aggregated mental state information. The aggregated mental state information may be received by a rendering module and may, in turn, be rendered by the rendering module. In one embodiment, the rendering comprises one or more lines on a graph, indicating a particular parameter as a function of time. The rendered output may be customized with various options, such as emphasizing a demographic 162. For example, a pollster or political analyst may be interested in observing the mental state of a particular demographic group, such as people of a certain age range, or gender, for example. The data may also be compared with self-report data 164 collected from the group of voters. In this way, the analyzed mental states can be compared with the self-report information to see how well they correlate. In some instances, people may self-report a mental state other than their true mental state. For example, in some cases people may self-report a certain mental state because they feel it is the “correct” response, or they are embarrassed to report their true mental state. The comparison with self-report data 164 can serve to identify situations where the analyzed mental state deviates from the self-reported mental state. The election behavior of an individual or group may be analyzed 166. The election behavior may include, but is not limited to, which candidate the voter voted for, or if the voter decided not to participate (i.e. did not vote). Thus, the election behavior may include information on which candidate the plurality of people voted for and the election behavior may include information on not voting by a subset of the plurality of people. The rendering may include an analysis of a candidate or candidates within the candidate interaction. The flow 100 may include analyzing the candidate for congruency 168 with the people who observe the candidate interaction. The congruency may be based on empathy between the viewers and the candidate and may involve mimicry, reflecting the candidate's mental states by the audience. Embodiments of the present invention may determine if there is a correlation between mental state and election behavior. Various steps in the flow 100 may be changed in order, repeated, omitted, or the like without departing from the disclosed inventive concepts.

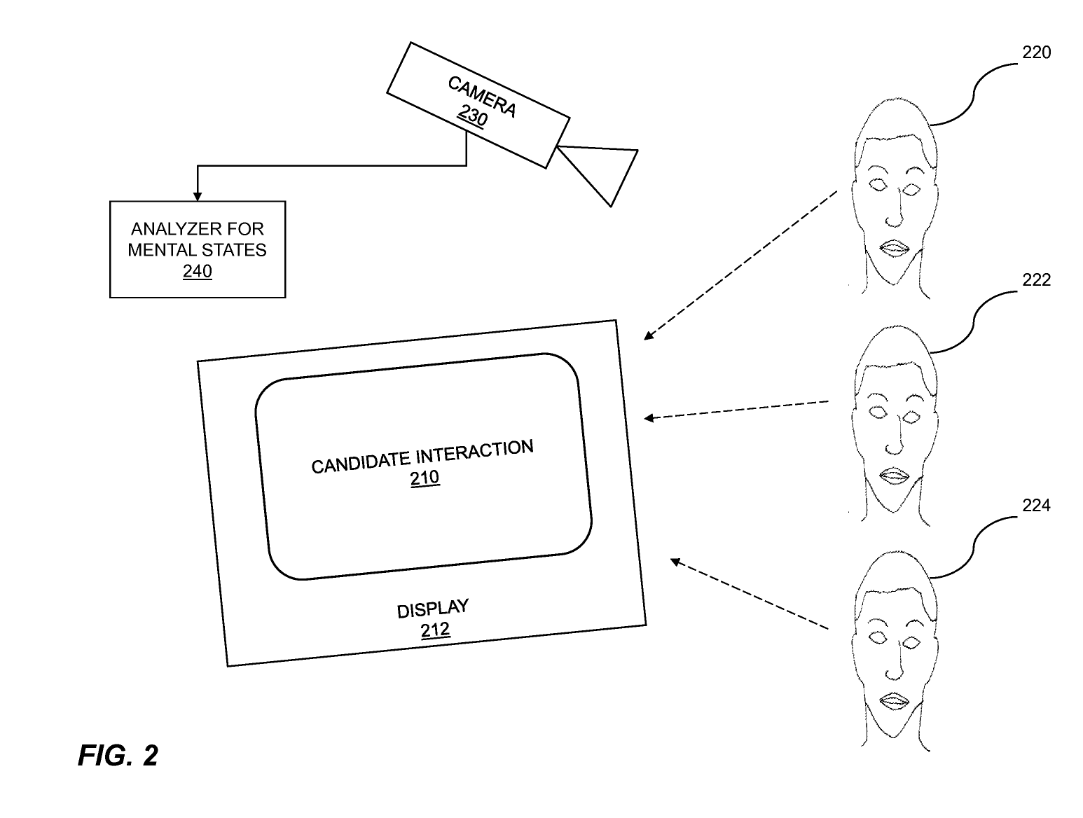

FIG. 2 is a diagram for collecting facial responses from a group. A display 212, such as a television monitor or projection apparatus presents a candidate interaction 210 to a group of users. FIG. 2 shows three individual voters, indicated as a first voter 220, a second voter 222, and a third voter 224. While three voters have been shown, in practical use, embodiments of the present invention may analyze groups comprised of tens, hundreds, or thousands of people or more. The term voters may refer to actual voters, potential voters, audience members, and the like. Each voter watches the candidate interaction 210. A candidate interaction 210 may be a political debate, a political speech, a news report, a campaign appearance, a town hall discussion, a political convention, a political advertisement, and so on. The candidate interaction 210 may include a recorded event. The plurality of people may be in a single audience. The plurality of people may be distributed in multiple locations. A portion of the plurality of people may be in an audience while a portion of the plurality of people is distributed in multiple locations.

While the voters are viewing the candidate interaction 210, a camera 230 records facial images of the voters. The images from the camera 230 are supplied to the analyzer for mental states 240. In embodiments, a webcam is used to capture one or more of the facial data and the physiological data. A camera may be used to capture mental state data on multiple people from the plurality of people. The camera 230 may refer to a webcam, a camera on a computer (such as a laptop, a net book, a tablet, or the like), a video camera, a still camera, a cell phone camera, a thermal imager, a CCD device, a three-dimensional camera, a depth camera, multiple webcams used to show different views of the voters or any other type of image capture apparatus that may allow data captured to be used in an electronic system. There may be a camera 230 per voter viewing the candidate interaction 210 where a webcam is used for each of the plurality of people. There may be multiple voters with a camera 230. In some embodiments, the voters may be in different locations, each viewing a display 212 with the candidate interaction 210. The analyzer for mental states 240 may comprise one or more processors on one or more computer systems. Embodiments may include various forms of distributed computing, client/server computing, cloud based computing, and the like.

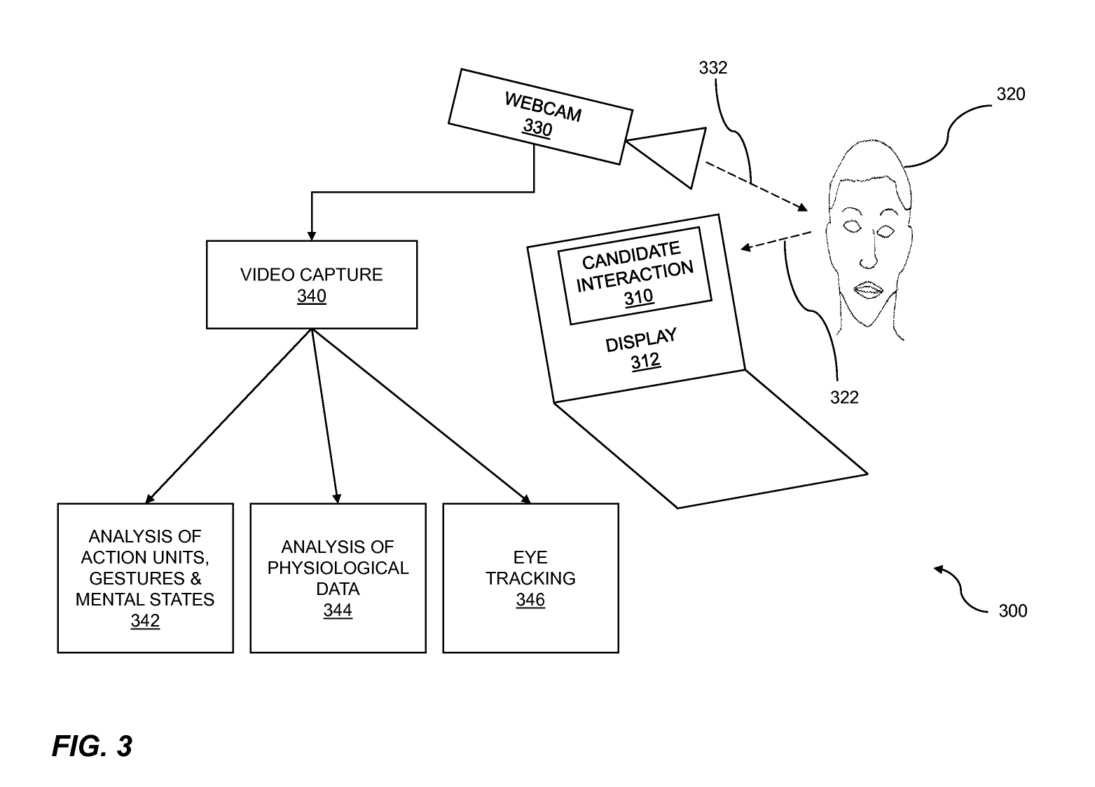

FIG. 3 is a diagram of a system 300 for capturing facial response to a candidate interaction 310. A voter 320 has a line-of-sight 322 to a display 312. The display 312 may be a television monitor, projector, computer monitor (including a laptop screen, a tablet screen, a net book screen, and the like), a cell phone display, a mobile device, or other electronic display. The display 312 presents a candidate interaction 310 to the voter 320. A webcam 330 is configured and disposed such that it has a line-of-sight 332 to the voter 320. In one embodiment, a webcam 330 is a networked digital camera that may take still and/or moving images of the face of the voter 320 and possibly the body of the voter 320 as well. The facial data from the webcam 330 is received by a video capture module 340 which may decompress the video into a raw format from a compressed format such as H.264, MPEG-2, or the like. The facial data may include information on action units, head gestures, smirks, smiles, brow furrows, squints, lowered eyebrows, raised eyebrows, and attention.

The raw video data may then be processed for analysis of facial data, action units, gestures, and mental states 342. The facial data may further comprise head gestures. The facial data itself may include information on one or more of action units, head gestures, smiles, brow furrows, squints, lowered eyebrows, raised eyebrows, attention, and the like. The action units may be used to identify smiles, frowns, and other facial indicators of mental states. Gestures may include tilting the head to the side, leaning forward, a smile, a frown, as well as many other gestures. Physiological data may be analyzed 344, and eyes may be tracked 346. Physiological data may be obtained through the webcam 330 without contacting the individual. The physiological data may also be obtained by a variety of sensors, such as electrodermal sensors, temperature sensors, and heart rate sensors. The physiological data may include one of a group comprising electrodermal activity, heart rate, heart rate variability, and respiration.

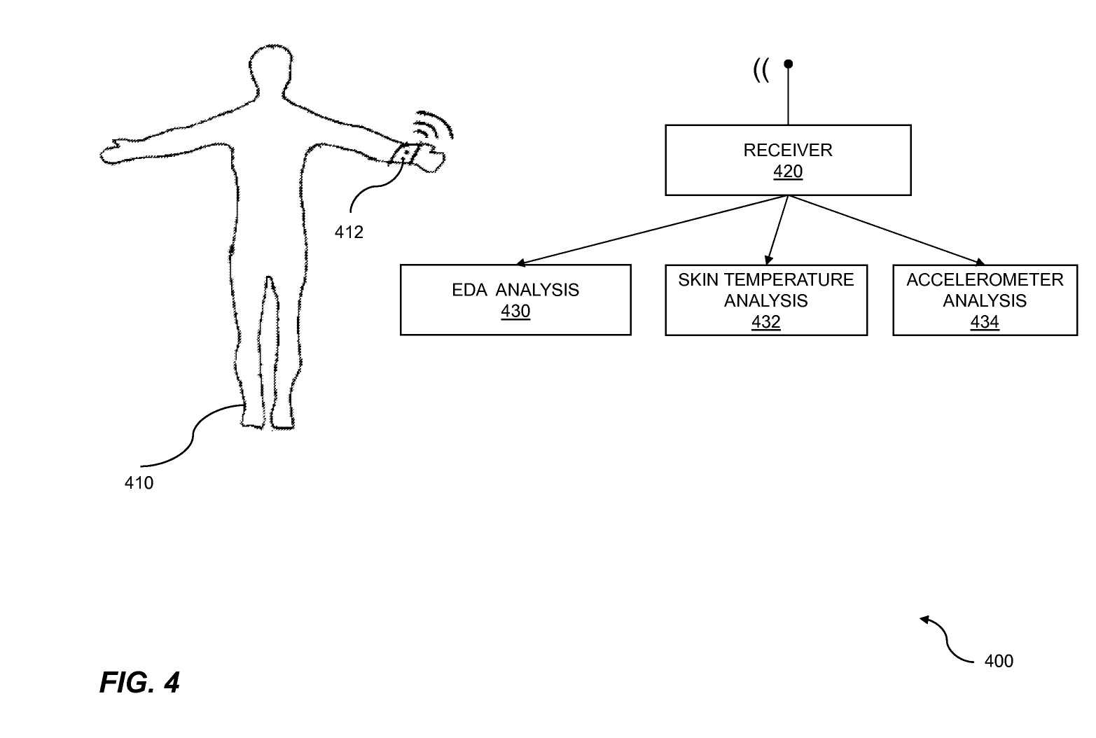

FIG. 4 is a diagram of a system 400 for physiological analysis. A voter 410 may have a sensor 412 attached to him or her for collection of mental state data. The mental state data may include one of a group comprising facial data, physiological data, and accelerometer readings. While FIG. 4 shows a sensor 412 attached to the wrist of the voter 410, in other embodiments the sensor 412 may be attached to the palm, hand, head, sternum, or other part of the body. In some embodiments, multiple sensors are placed on a voter 410, such as for example on both wrists. The sensor 412 may include detectors for electrodermal activity, skin temperature, and accelerometer readings. Other detectors may be included as well such as heart rate, blood pressure, and other physiological detectors. The sensor 412 may transmit information collected to a receiver 420 using wireless technology such as Wi-Fi, Bluetooth, 802.11, cellular, or other bands. In some embodiments, the sensor 412 may store information and burst-download the data through wireless technology. In other embodiments, the sensor 412 may store information for later wired download. The data collected by the receiver 420 may be supplied to an electrodermal activity (EDA) analysis module 430, a skin temperature analysis module 432, and an accelerometer analysis module 434. The physiological data, combined with the image data collected in the system shown in FIG. 3, may provide ways to infer the mental state or states of a voter 410.

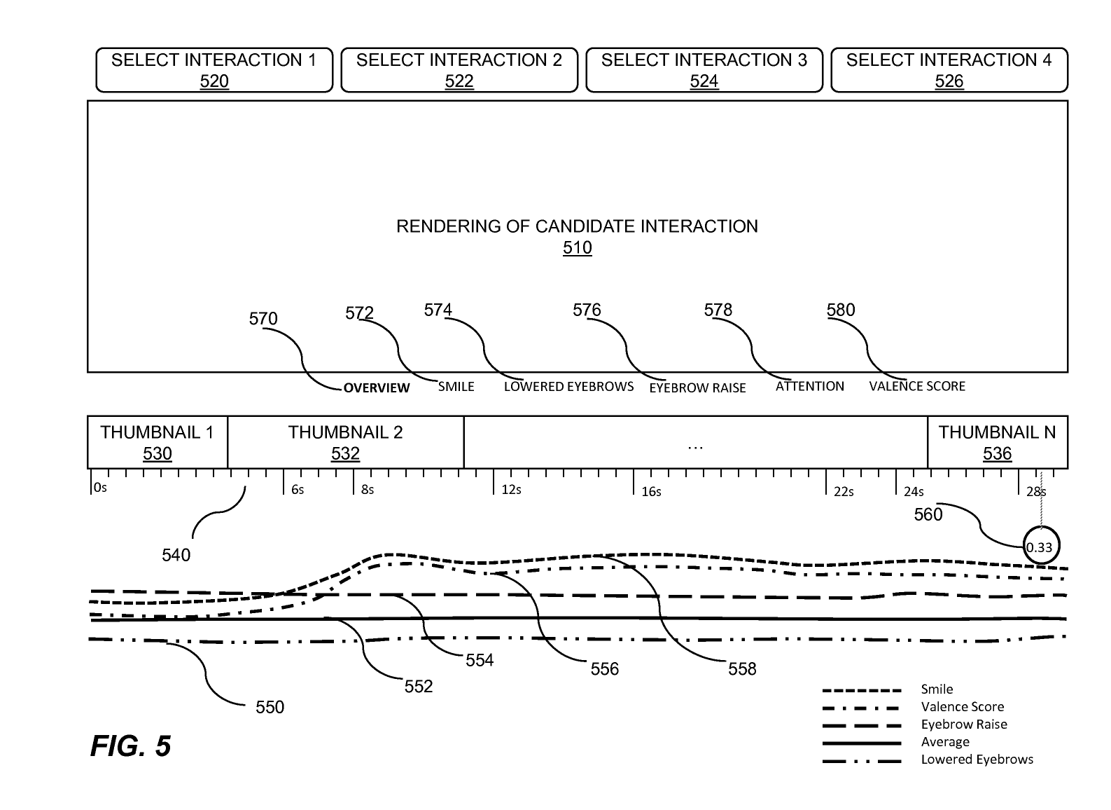

FIG. 5 is a graphical representation of mental state analysis which may be used for voter analysis. A window 500 may be shown which includes, for example, rendering of a candidate interaction 510 having associated mental state information. A user may be able to select between a plurality of candidate interactions using various buttons and/or tabs such as Select Interaction 1 button 520, Select Interaction 2 button 522, Select Interaction 3 button 524, and Select Interaction 4 button 526. Other numbers of selections are envisioned in various embodiments. In an alternative embodiment, a list box or drop-down menu may be used to present a list of candidate interactions for display. The user interface allows a plurality of parameters to be displayed as a function of time, synchronized to the candidate interaction. Various embodiments may have any number of selections available for the user and some may be other types of renderings instead of video. A set of thumbnail images for the selected rendering, that in the example shown, include thumbnail 1 530, thumbnail 2 532, through thumbnail N 536 which may be shown below the rendering along with a timeline 540. The thumbnails may show a graphical “storyboard” of the candidate interaction. This storyboard assists a user in identifying a particular scene or location within the candidate interaction. Some embodiments may not include thumbnails, or have a single thumbnail associated with the rendering. Various embodiments may have thumbnails of equal lengths while others may have thumbnails of differing lengths. In some embodiments, the start and/or end of the thumbnails may be determined based on changes in the captured mental states associated with the rendering or based on particular points of interest in the candidate interaction.

Some embodiments may include the ability for a user to select a particular type of mental state information for display using various buttons or other selection methods. In the example shown, the smile mental state information is shown as the user may have previously selected the Overview button 570. Other types of mental state information that may be available for user selection in various embodiments may include the Smile button 572, the Lowered Eyebrows button 574, Eyebrow Raise button 576, Attention button 578, Valence Score button 580 or other types of mental state information, depending on the embodiment. The Overview button 570 may be available to allow a user to show graphs of the multiple types of mental state information simultaneously.

A plurality of graph lines is displayed along a timeline 540. A line 550 may represents lowered eyebrows. Another line 552 may represent an overview and may, in some cases, be an average of other lines. A third line 554 may represent an eyebrow raise. A fourth line 556 may represent a valence score. A fifth line 558 may represent smiling. A time cursor 560 may be used to retrieve the portion of the candidate interaction that temporally corresponds to that point on the curves. The various demographic based graphs may also be shown and indicated using various line types as shown or may be indicated using color or other method of differentiation. A time cursor 560 may allow a user to select a particular time of the timeline and show the value of the chosen mental state for that particular time. The slider may show the same line type or color as the demographic group whose value is shown. Such demographics may include gender, age, race, income level, or any other type of demographic including dividing the respondents into those respondents that had a higher (or more expressive) reaction from those with lower reactions. A graph legend may be displayed indicating the various demographic groups, the line type or color for each group, the percentage of total respondents and or absolute number of respondents for each group, and/or other information about the demographic groups. The mental state information may be aggregated according to the demographic type selected. Thus, aggregation of the aggregated mental state information is performed on a demographic basis so that mental state information is grouped based on the demographic basis for some embodiments.

By way of exemplary use, a campaign team for a politician may wish to test the effectiveness of a political message. An advertisement may be shown to a plurality of voters in a focus group setting. The campaign team may notice an inflection point in one or more of the curves, for example a smile line may be used. The campaign team can then identify which point in the candidate interaction, in this case a political advertisement, invoked smiles from the voters. Thus, content can be identified by the campaign as being effective or at least drawing a positive response. In his manner, voter response can be obtained and analyzed. Thus, the rendering may be accomplished using a dashboard. Rendering the aggregated mental state information may also include highlighting portions of the candidate interaction based on the mental state data collected.

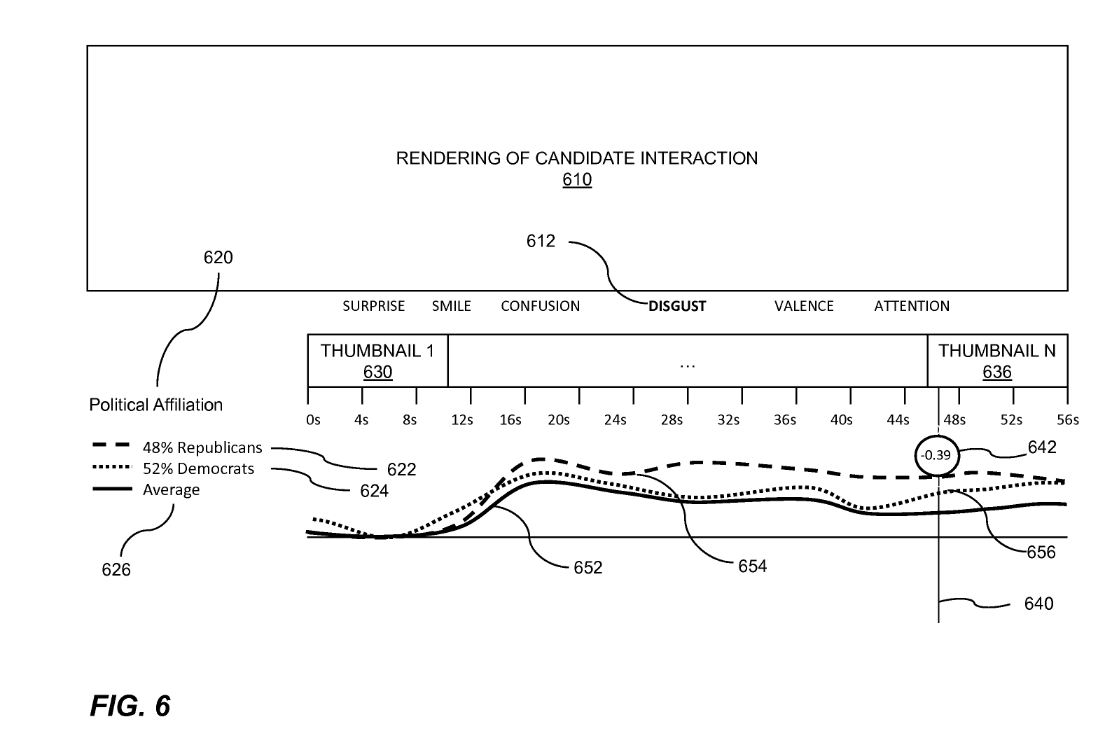

FIG. 6 is a graphical rendering with demographic information. A rendering of the candidate interaction 610 is presented. Various demographics may be selected such as political affiliation 620. A group of republicans 622, a group of democrats 624, and an overall average 626 may be identified. In embodiments, independents or third party affiliations may be identified. The demographic information may include, but is not limited to, political affiliation, age range, gender, ethnicity, nationality, religious affiliation, level of education, income bracket, and residence information. Thus, the multiple demographic groups may be based on one or more of age, political affiliation, gender, geographic location, and ethnicity. A plurality of thumbnail images, including a first thumbnail 630 through an N^{th} thumbnail 636 may show a graphic “storyboard” of the candidate interaction. A line corresponding to each demographic group may be displayed for a given parameter. Various mental states or facial expressions could be chosen for analysis including Surprise, Smile, Confusion, Disgust, Valence, or Attention. In FIG. 6, the selected parameter is Disgust 612. A line for each demographic group is rendered for the selected parameter. In this example, a first line 652 may correspond to democrats, a second line 654 may correspond to republicans, and a third line 656 may correspond to the entire group. The rendering may show the aggregated mental state information so that one of multiple demographic groups is emphasized.

A cursor line 640 and a time indicator 642 are used to identify a particular point in time within the candidate interaction. In this example, the parameter selected is lowered eyebrows. Suppose that lowered eyebrows are used as an indication of possible confusion or disbelief. A data analyst can track where republicans lowered their eyebrows and determine which part of the candidate interaction caused that response. A similar analysis may be performed for democrats. In this way the data analyst can determine where democrats and republicans may respond differently to various parts of a candidate interaction. Hence, embodiments of the present invention provide for a testing of messaging, and allow a candidate interaction to be “fine tuned” by creating multiple iterations of a candidate interaction and testing with multiple sets of focus groups.

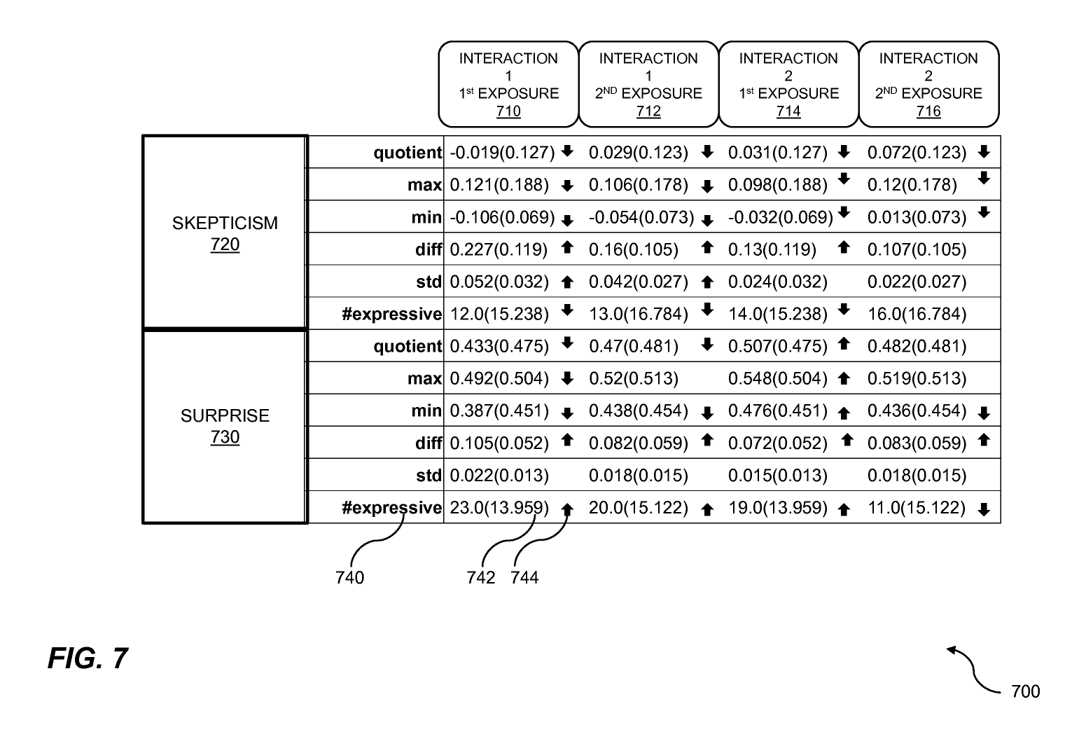

FIG. 7 is an example rendering including norms. A tabular representation 700 is shown with a table for Skepticism 720 and Surprise 730. The tabular results from two different interactions and two separate exposures are shown for each of those interactions. An interaction 1, first exposure image 710 is shown as well as an interaction 1, second exposure image 712. An interaction 2, first exposure image 714 is shown as well as an interaction 2, second exposure image 716. The interactions could be an advertisement or other type of political presentation. The various images could be an image selected from a video of their respective interactions. Based on a first versus a second exposure analysis, a determination could be made on value of showing an interaction multiple times. Values in a table could include a quotient for the mental state, a maximum value, a minimum value, a difference between the minimum and maximum value, a standard deviation, and a number of viewers who were expressive 740 of such a mental state upon seeing the interaction. Norms could be shown in parenthesis 742 for values expected for such a candidate interaction. Arrows 744 could be shown indicating when a value deviated significantly from such a norm. Numerous other types of tabular representation could be provided as well.

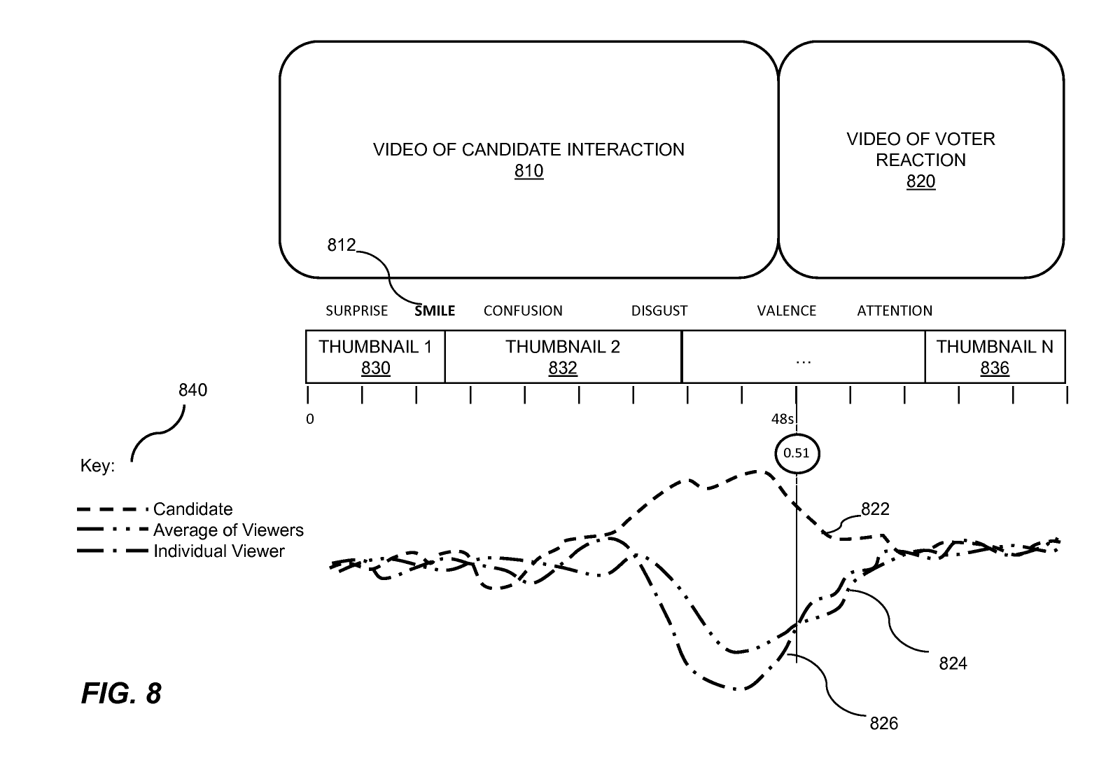

FIG. 8 is an example graphical rendering including both the candidate interaction and a video of voter reaction. A video of a candidate interaction 810 as well as a video of voter reaction 820 may be shown on the rendering. The video of voter reaction 820 may be for a single voter or may be for an audience of multiple voters. In some cases, the video of voter reaction 820 may be multiple individual videos for multiple voters. A plurality of thumbnail images, including a first thumbnail 830, a second thumbnail 832, through an N^{th} thumbnail 836 may show a graphic “storyboard” of the candidate interaction. The thumbnails rendering may include highlights from the candidate interaction. The highlights may be automatically chosen based on expressions or mental states of the candidate or may be automatically chosen based on expressions or mental states of the viewer or viewers. In some embodiments, the highlights may include the top five, or other number, of highlights. In embodiments, the highlights are automatically chosen as those which are most polarizing based on the aggregated mental state information. Multiple mental states or facial expressions may be selected with a graph shown for summarizing that mental state or facial expression. In this example Smile 812 is selected. A graph 822 for the candidate is shown as well as a graph 824 for the viewer and a graph 826 for an average of viewers is shown. At one point, at approximately time equal to 43 seconds, the candidate smile graph 822 peaks while the viewers' smile graphs 824, 826 are in a trough. In this case the mental state of the candidate is incongruous with the viewers. This incongruity could be very disconcerting to viewers. For example, if the candidate told a story of a horrible event, the viewers might frown and not smile. If, however, the candidate smiled at this time, the candidate could be viewed as being gleeful over this horrible event. Analysis like this could be helpful in feedback to a candidate to help him or her become more empathetic with an audience. Incongruity may also be a reflection of skepticism on the part of the audience.

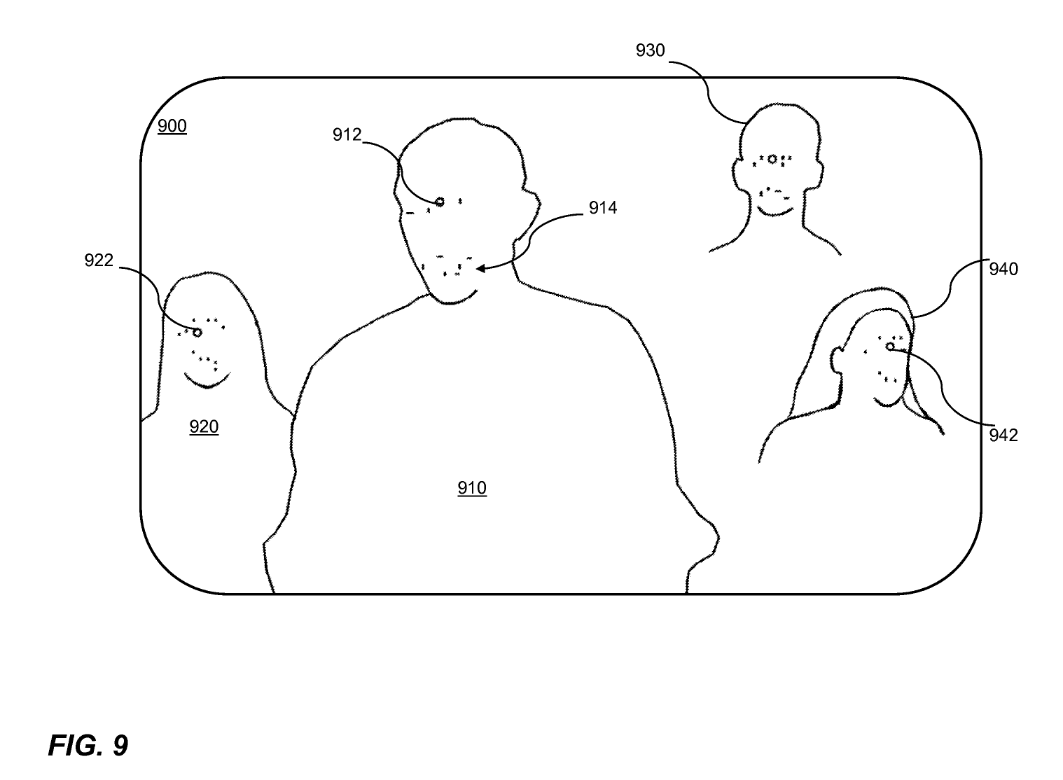

FIG. 9 is an example graphical rendering showing a candidate interaction along with voter reaction. A video image 900 is shown with a candidate 910 and several viewers 920, 930, 940 of the candidate. In some embodiments, the candidate 910 and the viewers 920, 930, 940 may be in the same image 900. In other cases, the candidate 910 can be in one image and the viewers can be in another or multiple other images. The candidate 910 may have a focus 912 identified. The focus 912 may indicate the direction in which the candidate 910 is looking The candidate 910 may also have facial features or boundaries of features 914 identified. The boundaries 914 could be marking the corners of the mouth, eyebrows, and other landmarks on the face. Likewise the viewers may have their focus and facial features identified. A focus 922 is shown for the viewer 920. A focus 942 is shown for the viewer 940. In the case of viewer 940, the focus 942 is away from the candidate. By analyzing the focus and the features, mental state analysis can be performed on the candidate and the viewers. In some embodiments, analysis can be performed to determine when the candidate and the viewers have synchronized mental states. Additionally, times when the mental states are incongruous can be identified.

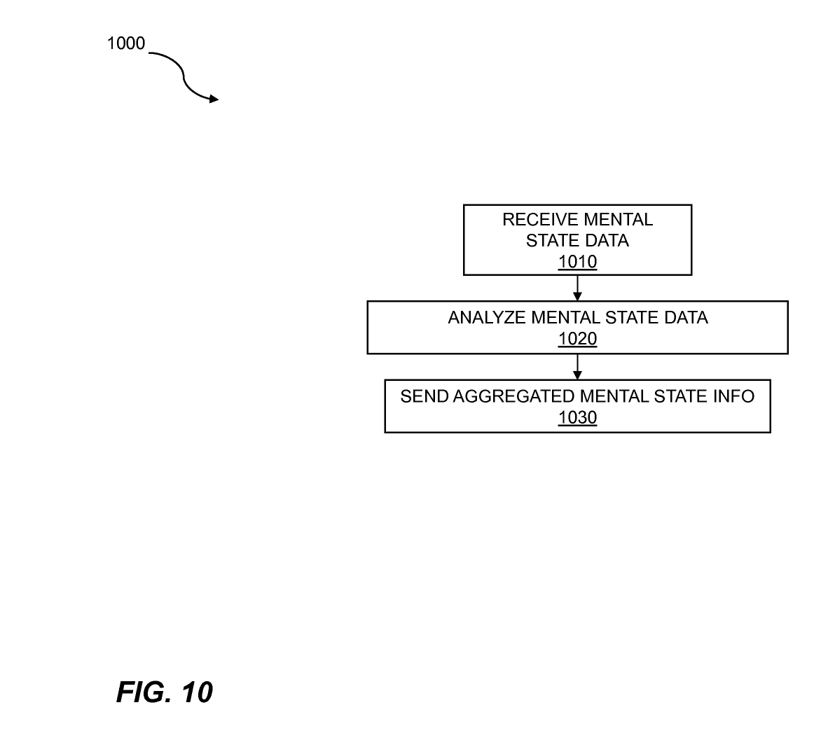

FIG. 10 is a flow diagram for analyzing voter reaction. A flow 1000 shows a possible sequence from a server machine perspective. The flow 1000 may include receiving mental state data 1010, which was collected, from a plurality of people as they observe a candidate interaction. The mental state data may have been collected from one or more client machines. The mental state data may have been collected from multiple people in a single room viewing a candidate interaction, either in person or through a media presentation; from multiple people in one room and then some people distributed in other locations; or from multiple people who are distributed in various locations. The flow 1000 may include analyzing the mental state data 1020, which was received, to produce an aggregated mental state information on the plurality of people. The aggregated mental state information can be a combination of mental state data from people viewing the candidate interaction. The aggregated mental state information can be based on demographic data. Numerous other ways of combining the aggregated mental state information are possible. The flow 1000 may include sending the aggregated mental state information 1030 to a client machine so that an analysis of the mental state data is rendered based on the aggregated mental state information. The aggregated mental state information may be presented in various graphical renderings. Various steps in the flow 1000 may be changed in order, repeated, omitted, or the like without departing from the disclosed inventive concepts. Various embodiments of the flow 1000 may be included in a computer program product embodied in a non-transitory computer readable medium that includes code executable by one or more processors.

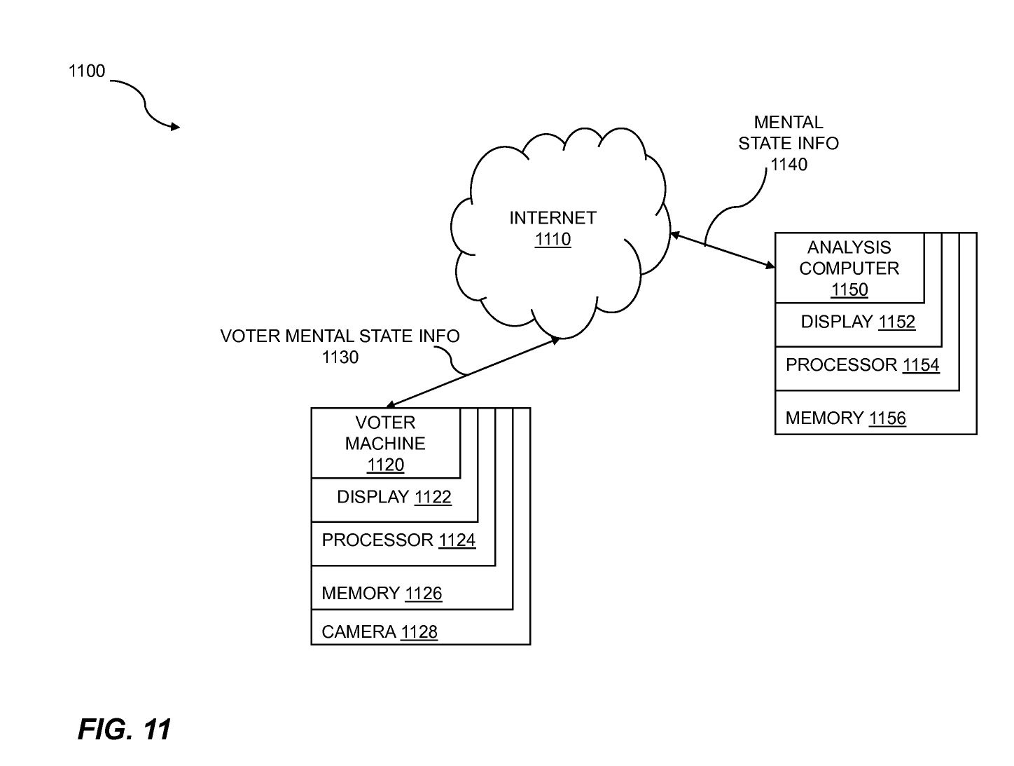

FIG. 11 is a diagram of a system 1100 for analyzing voter response utilizing multiple computers. The internet 1110, intranet, or other computer network may be used for communication between the various computers. A voter machine or client computer 1120 has a memory 1126 which stores instructions and one or more processors 1124 coupled to the memory 1126 wherein the one or more processors 1124 can execute instructions. The memory 1126 may be used for storing instructions, for storing mental state data, for system support, and the like. The client computer 1120 may have an internet connection to carry voter mental state information 1130 and a display 1122 that may present various client interactions to one or more voters. The display 1122 may be any electronic display, including but not limited to, a computer display, a laptop screen, a net-book screen, a tablet computer screen, a cell phone display, a mobile device display, a remote with a display, a television, a projector, or the like. A camera 1128 may be attached to the voter machine 1120 where the camera 1128 is used to collect facial and other types of images. The camera 1128, as the term is used herein, may refer to a webcam, a video camera, still camera, thermal imager, CCD device, phone camera, three-dimensional camera, a depth camera, multiple webcams used to show different views of a person, or any other type of image capture apparatus that may allow data captured to be used in an electronic system. The client computer 1120 may be able to collect mental state data from a plurality of voters as they observe the candidate interaction. In some embodiments there may be multiple client computers 1120 so that each may collect mental state data from one voter or a plurality of voters as they observe a candidate interaction. In some embodiments, the client computer 1120 may receive mental state data collected from a plurality of voters as they observe the candidate interaction. Once the mental state data has been collected the client computer may upload information to a server or analysis computer 1150, based on the mental state data from the plurality of voters who observe the candidate interaction. The client computer 1120 may communicate with the server 1150 over the internet 1110, some other computer network, or by other method suitable for communication between two computers. In some embodiments, the analysis computer 1150 functionality may be embodied in the client computer.

The analysis computer 1150 may have an internet connection to receive mental state information 1140 into the analysis computer 1150 and have a memory 1156 which stores instructions and one or more processors 1154 coupled to the memory 1156 wherein the one or more processors 1154 can execute instructions. The analysis computer 1150 may receive mental state information collected from a plurality of voters from the client computer 1120 or computers, and may aggregate mental state information on the plurality of voters who observe the candidate interaction. The analysis computer 1150 may also associate the aggregated mental state information with the rendering and also with the collection of norms for the context being measured.

The analysis computer 1150 may have a memory 1156 which stores instructions and one or more processors 1154 attached to the memory 1156 wherein the one or more processors 1154 can execute instructions. The memory 1156 may be used for storing instructions, for storing mental state data, for system support, and the like. The analysis computer may use its internet connection, or other computer communication method, to obtain mental state information 1140. In some embodiments, the analysis computer 1150 may receive aggregated mental state information, based on the mental state data from the plurality of voters who observe the candidate interaction and may present aggregated mental state information in a rendering on a display 1152. In some embodiments, the analysis computer may be set up for receiving mental state data collected from a plurality of voters as they observe the candidate interaction, in a real-time or near real-time embodiment. In at least one embodiment, a single computer may incorporate the client, server and analysis functionality. The system 1100 may include code for collecting mental state data from a plurality of people as they observe a candidate interaction; code for uploading information, to a server, based on the mental state data from the plurality of people who observe the candidate interaction; code for receiving aggregated mental state information on the plurality of people who observe the candidate interaction; and code for rendering an output based on the aggregated mental state information.

Each of the above methods may be executed on one or more processors on one or more computer systems. Embodiments may include various forms of distributed computing, client/server computing, and cloud based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams, show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general purpose hardware and computer instructions, and so on.

A programmable apparatus which executes any of the above mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are neither limited to conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM), an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States then the method is considered to be performed in the United States by virtue of the causal entity.

While the invention has been disclosed in connection with preferred embodiments shown and described in detail, various modifications and improvements thereon will become apparent to those skilled in the art. Accordingly, the forgoing examples should not limit the spirit and scope of the present invention; rather it should be understood in the broadest sense allowable by law.

1. A computer implemented method for voter analysis comprising:
collecting mental state data from a plurality of people as they observe a candidate interaction;
uploading information, to a server, based on the mental state data from the plurality of people who observe the candidate interaction;
receiving aggregated mental state information on the plurality of people who observe the candidate interaction; and
rendering an output based on the aggregated mental state information.

2. The method of claim 1 wherein the information, which is uploaded, includes one or more of the mental state data, analysis of the mental state data, and a probability score for mental states.

3. The method of claim 1 further comprising inferring mental states based on the mental state data which was collected wherein the mental states include one or more of frustration, confusion, disappointment, hesitation, cognitive overload, focusing, engagement, attention, boredom, exploration, confidence, trust, delight, disgust, skepticism, doubt, and satisfaction.

4. The method of claim 1 wherein the collecting is part of a voter polling process.

5. The method of claim 1 wherein the aggregated mental state information allows evaluation of a collective mental state of the plurality of people.

6. The method of claim 1 further comprising developing norms based on the aggregated mental state information.

7. The method of claim 1 further comprising developing an affinity group based on the aggregated mental state information.

8. The method of claim 1 further comprising sharing the mental state information across a social network.

9. The method of claim 1 wherein the aggregated mental state information is aggregated separately for multiple demographic groups.

10. The method of claim 9 wherein the multiple demographic groups are based on one or more of age, political affiliation, gender, geographic location, and ethnicity.

11. The method of claim 9 wherein the rendering is accomplished using a dashboard.

12. The method of claim 11 wherein the rendering includes highlights from the candidate interaction.

13. The method of claim 11 wherein the rendering includes an analysis of a candidate within the candidate interaction.

14. The method of claim 13 further comprising analyzing the candidate for congruency with the plurality of people who observe the candidate interaction.

15. The method of claim 1 further comprising aggregating information to generate the aggregated mental state information from a plurality of people.

16. The method of claim 1 further comprising rendering the aggregated mental state information so that one of multiple demographic groups is emphasized.

17. The method of claim 1 wherein the candidate interaction includes one or more of a debate, a town hall discussion, a campaign appearance, a political advertisement, a testing of messaging, a live event, and a recorded event.

18. The method of claim 1 wherein the plurality of people are in a single audience.

19. The method of claim 1 wherein the plurality of people are distributed in multiple locations.

20. The method of claim 1 wherein a portion of the plurality of people are in an audience and a portion of the plurality of people are distributed in multiple locations.

21. The method of claim 1 further comprising tracking of eyes to identify a portion of the candidate interaction for which the mental state data is collected.

22. The method of claim 1 further comprising analyzing election behavior for the plurality of people on which mental state data was collected.

23. The method of claim 22 wherein the election behavior includes information which candidate the plurality of people voted for.

24. The method of claim 22 wherein the election behavior includes information on not voting by a subset of the plurality of people.

25. The method of claim 1 further comprising comparing the mental state data to norms which have been determined.

26. (canceled)

27. The method of claim 1 wherein rendering the aggregated mental state information includes highlighting portions of the candidate interaction based on the mental state data collected.

28-34. (canceled)

35. The method of claim 28 wherein the physiological data is collected without contacting the plurality of people.

36-39. (canceled)

40. A computer program product embodied in a non-transitory computer readable medium for voter analysis, the computer program product comprising:
code for collecting mental state data from a plurality of people as they observe a candidate interaction;
code for uploading information, to a server, based on the mental state data from the plurality of people who observe the candidate interaction;
code for receiving aggregated mental state information on the plurality of people who observe the candidate interaction; and
code for rendering an output based on the aggregated mental state information.

41. A computer system for voter analysis comprising:
a memory which stores instructions;
one or more processors attached to the memory wherein the one or more processors, when executing the instructions which are stored, are configured to:
collect mental state data from a plurality of people as they observe a candidate interaction;
upload information, to a server, based on the mental state data from the plurality of people who observe the candidate interaction;
receive aggregated mental state information on the plurality of people who observe the candidate interaction; and
render an output based on the aggregated mental state information.

42. A computer implemented method for voter analysis comprising:
receiving mental state data, which was collected, from a plurality of people as they observe a candidate interaction;
analyzing the mental state data, which was received, to produce an aggregated mental state information on the plurality of people; and
sending the aggregated mental state information to a client machine so that an analysis of the mental state data is rendered based on the aggregated mental state information.
